(19) United States
(12) Patent Application Publication
(10) Pub. No.: US 2024/0217071 A1
(43) Pub. Date: Jul. 4, 2024

(54) WRENCH

(71) Applicant: Milwaukee Electric Tool Corporation, Brookfield, WI (US)

(72) Inventor: Caleb C. Adams, Milwaukee, WI (US)

(21) Appl. No.: 18/512,496

(22) Filed: Nov. 17, 2023

Related U.S. Application Data
(60) Provisional application No. 63/477,665, filed on Dec. 29, 2022.

(51) Int. Cl. B25B 13/18; B25B 13/38

(52) U.S. Cl. CPC B25B 13/18; B25B 13/38

(57) ABSTRACT

Various embodiments of a hand tool shown a wrench are provided. The wrench includes an adjustable head that allows for use within small spaces such as around plumbing fixtures. Various embodiments include a head with a fixed jaw and a moveable jaw such that a position of the moveable jaw relative to the fixed jaw is adjustable when the adjustment mechanism is actuated. In a specific embodiment, the adjustment mechanism allows a user to change the position of the head with one hand and/or a thumb.

### CROSS-REFERENCE TO RELATED PATENT APPLICATION

The present application claims the benefit of and priority to U.S. Provisional Application No. 63/477,665 filed on Dec. 29, 2022, which is incorporated herein by reference in its entirety.

### BACKGROUND OF THE INVENTION

The present invention relates generally to the field of hand tools. The present invention relates specifically to a wrench, such as a faucet wrench, a self-tightening wrench, etc.

### SUMMARY OF THE INVENTION

One embodiment of the invention relates to an adjustable wrench including a handle extending along a longitudinal axis of the wrench and a wrench head. The wrench head includes a moveable jaw and a fixed jaw. The fixed jaw is coupled to the handle and includes a first contact surface. The moveable jaw is slidably coupled to the handle and includes a neck extending along the longitudinal axis and positioned within the handle and a second contact surface. The second contact surface faces the first contact surface. The wrench further includes an adjustment mechanism including a neck slider, a switching device, and a biasing member. The neck slider extends along the longitudinal axis and faces the neck. The switching device includes an engagement arm configured to engage the neck slider. The biasing member extends between and couples the handle to the moveable jaw. The biasing member biases the moveable jaw toward the handle. The wrench head is adjustable between a closed position in which the moveable jaw is engaged with the fixed jaw and an open position in which the moveable jaw is spaced a distance from the fixed jaw.

Another embodiment of the invention relates to a wrench including a handle and a head. The handle includes a cavity. The head includes a fixed jaw and a moveable jaw. The fixed jaw is coupled to the handle and includes a first contact surface. The moveable jaw is slidably coupled to the handle and includes a neck extending along the longitudinal axis and positioned within the cavity and a second contact surface. The second contact surface faces the first contact surface. The wrench further includes an adjustment mechanism including a neck slider, a switching device, and a spring. The neck slider extends along the neck and faces the neck. The switching device includes an actuating surface extending along a length of the handle and an engagement arm. The engagement arm extends into the cavity and is configured to engage the neck slider. The spring extends between and couples the handle to the moveable jaw. When the user grasps the handle with a hand, the switching device is actuatable by the hand of the user.

Another embodiment of the invention relates to an adjustable wrench including a handle and a head. The handle extends along a longitudinal axis. The head includes a fixed jaw and a moveable jaw. The fixed jaw is coupled to the handle and includes a first contact surface. The moveable jaw is slidably coupled to the handle and includes a neck extending along the longitudinal axis and positioned within the handle and a second contact surface. The second contact surface faces the first contact surface. The wrench further includes an adjustment mechanism including a neck slider, a switching device, and a biasing member. The neck slider extends along the longitudinal axis and is engaged with the neck. The switching device includes an engagement arm configured to engage the neck slider. The biasing member extends between and couples the handle to the moveable jaw. When the switching device is engaged by a user and moved toward the head, the engagement arm pushes the neck slider toward the head, moving the moveable jaw away from the handle.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top perspective view of a wrench, according to an exemplary embodiment.

FIG. 2 is a bottom perspective view of the wrench of FIG. 1, according to an exemplary embodiment.

FIG. 3 is a bottom perspective view of the wrench of FIG. 1 with a head in an open position, according to an exemplary embodiment.

FIG. 4 is a cross-sectional view taken along line 4-4 of FIG. 1, according to an exemplary embodiment.

FIG. 5 is the cross-sectional view of the wrench of FIG. 1 with the head in the open position, according to an exemplary embodiment.

FIG. 6 is a partially exploded view of the wrench of FIG. 1, according to an exemplary embodiment.

FIG. 7 is an exploded view of an adjustment mechanism of the wrench of FIG. 1, according to an exemplary embodiment.

FIG. 8 is a cross-sectional view taken along line 8-8 of FIG. 2, according to an exemplary embodiment.

FIG. 9 is a cross-sectional view taken along line 9-9 of FIG. 3, according to an exemplary embodiment.

### DETAILED DESCRIPTION

Referring generally to the figures, various embodiments of wrenches, such as plumbing wrenches, faucet wrenches, etc. are provided. As discussed herein, Applicant has developed a number of improvements to such wrenches as described herein. In contrast to the wrenches discussed herein, many wrenches may have difficulty being maneuvered or adjusted within small spaces such as around plumbing fixtures (e.g., under sinks, close to walls or other plumbing fixtures). Applicant has designed an adjustment mechanism that allows a user to change the position of a wrench head, and specifically changes the position of a moveable jaw relative to a fixed jaw with one hand. The adjustment mechanism allows the user to alter the position of the moveable jaw which can then be fitted to the dimension of a workpiece. In a specific embodiment, the adjustment mechanism includes a switching or sliding device that can be actuated by a thumb. The adjustability of the wrench head allows a user to tighten and loosen a variety of workpieces with various diameters, while the ability to perform the adjustment with a single hand allows for use in tight spaces where a second hand may not fit.

Additionally, in various embodiments, the wrench includes a single handle with a spring-loaded jaw. In contrast to the wrenches discussed herein, many wrenches require two handles with the second handle required to reach a desired jaw pressure and/or clamping force. As will generally be understood, for wrenches such as faucet wrenches, clamping force is important for ensuring that a fastener (i.e., nut) is not damaged and/or rounded off during tightening or loosening of the fastener because faucet wrenches are typically used with chrome-plated fixtures. Applicant believes using spring loading to close the jaws of the wrench instead allows for a wrench design with a single handle that includes a desired clamping force (i.e., apply enough force on the fastener to tighten and/or loosen the fastener without damaging the fastener). The use of a single wrench handle further improves the ability to maneuver or adjust the wrench discussed herein within the small spaces around plumbing fixtures.

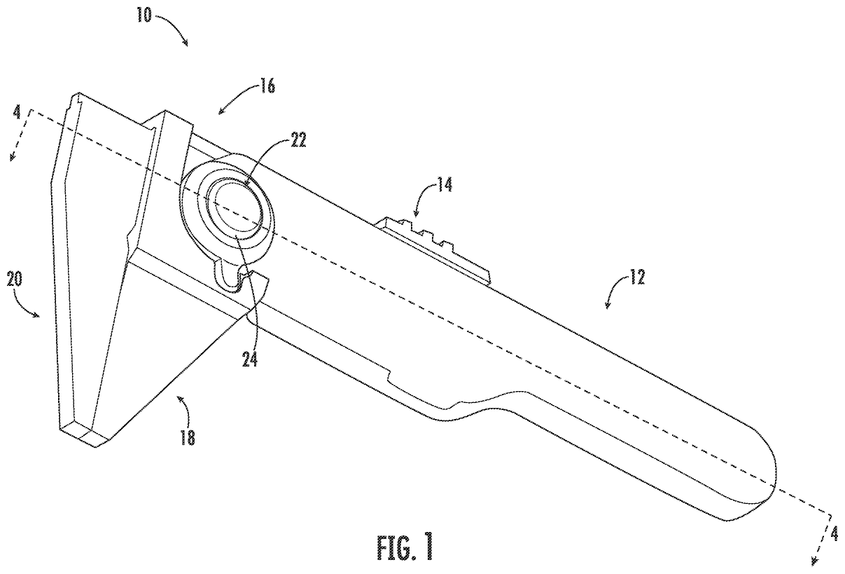

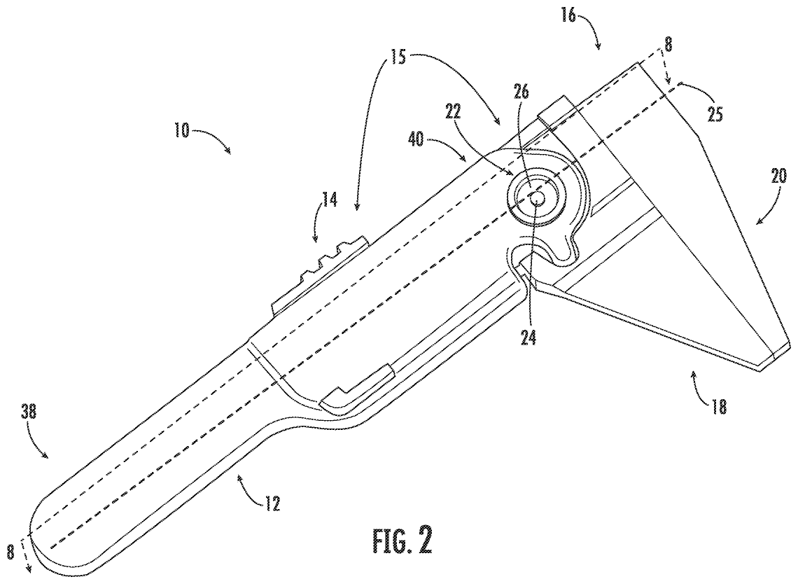

Referring to FIGS. 1-2, various aspects of a wrench, shown as a pliers wrench 10 with an adjustable wrench head 16 are shown. Wrench 10 includes a shank or handle 12 extending from wrench head 16 along a longitudinal axis 25 (see e.g., FIG. 2). In various embodiments, handle 12 is a single, integral component. Wrench head 16 includes a lower or fixed jaw 18 and an upper, moveable and/or adjustable jaw 20. An adjustment mechanism 15 allows a user to move and/or adjust wrench head 16. Adjustment mechanism 15 includes a switching device or slider, shown as thumb slider 14 that moves adjustable jaw 20 toward and/or away from fixed jaw 18 when engaged by a user. The adjustability of wrench head 16 allows a user to tighten and/or loosen a variety of workpieces with various dimensions, diameters and/or sizes.

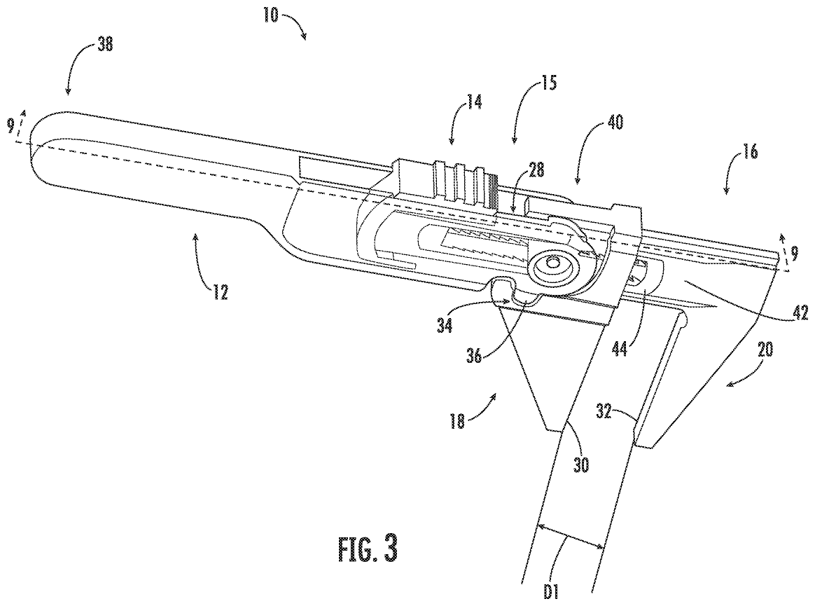

Referring to FIGS. 2-3, adjustable jaw 20 is connected to a neck 42 that extends into handle 12 when wrench 10 is assembled. In other words, neck 42 is at least partially positioned within handle 12 when wrench 10 is assembled. Adjustment mechanism 15 further includes a release button 22. When the user is ready to adjust wrench 10, engaging the thumb slider 14 and specifically pushing thumb slider 14 toward wrench head 16 will move the thumb slider 14 and a neck slider 44. Neck slider 44 is positioned within handle 12 and extends along neck 42. The movement of the thumb slider 14 causes neck slider 44 to release and/or disengage release button 22 such that wrench head 16 is adjustable.

As will be discussed in greater detail below, when release button 22 is disengaged from neck 42, wrench 10 is in a sliding or moving position and can be adjusted for a specific workpiece (i.e., wrench head 16 is in an unlocked position). In other words, adjustable jaw 20 is moveable toward and/or away from fixed jaw 18 when wrench 10 is in the sliding or unlocked position. When the wrench head 16 is in a locked or engaged position, the release button 22 is engaged with the neck 42 such that moveable jaw 20 is fixed with respect to handle 12.

Release button 22 includes a button portion 24 and a receiver 26. Receiver 26 is positioned within handle 12 and configured to receive and engage with button portion 24. When release button 22 moves toward and/or into handle 12, release button 22 moves in a direction generally perpendicular (i.e., 90 degrees plus or minus 10 degrees) to longitudinal axis 25 of wrench 10.

Fixed jaw 18 includes a first jaw contact surface or face 30 and adjustable jaw 20 includes a second jaw contact surface or face 32. A distance D1 is defined between jaw surfaces 30 and 32. In a specific embodiment D1 is adjustable between 0 and 2.5 inches. The adjustability of head 16 allows a user to tighten and loosen a variety of workpieces with various dimensions and/or diameters. In a specific embodiment, D1 includes a range such that workpieces with various diameters can be grasped by head 16 (i.e., ¾ inch nut, 2 inch nut, 2 ⅜ inch nut, etc.).

Handle 12 includes a gripping or distal end 38 configured to be grasped by a user and a proximal end 40 positioned adjacent to head 16. A cavity 28 is positioned within handle 12. In a specific embodiment, cavity 28 is positioned at the proximal end 40 of handle 12. Handle 12 further includes a cam 36 located at proximal end 40 of handle 12. Fixed jaw 18 includes a cam recess 34 that has a size corresponding to cam 36 and is configured to engage cam 36. Cam 36 applies pressure and/or a force on fixed jaw 18 when torque is applied to a workpiece.

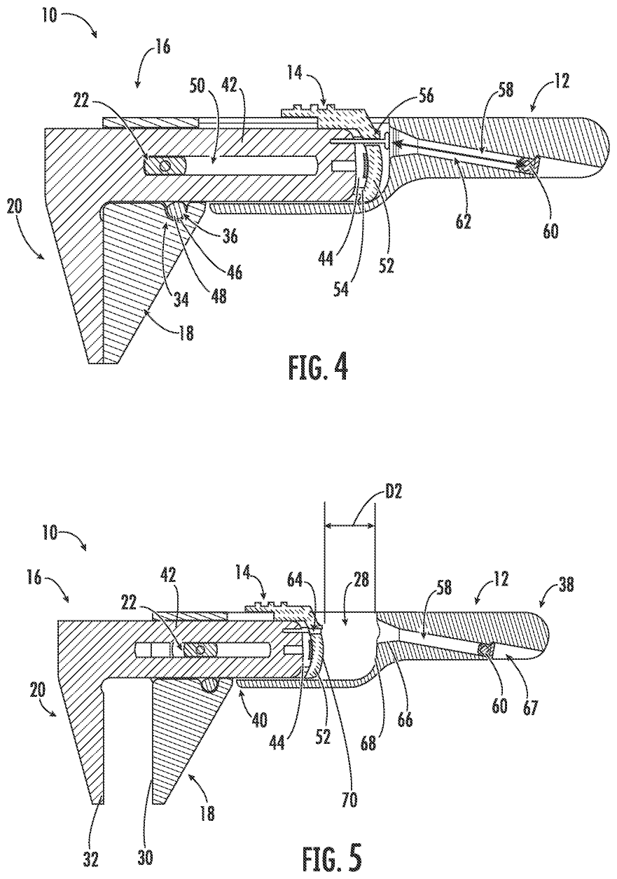

Referring to FIGS. 4-5, cross-sectional views of wrench 10 with wrench head 16 in a closed and open position are shown, according to an exemplary embodiment. As shown in FIG. 4, when wrench head 16 is in the closed position, jaw face 32 of adjustable jaw 20 and jaw face 30 of fixed jaw 18 are touching and/or engaged with each other such that D1 is about zero. When a user provides a force to thumb slider 14 such that thumb slider 14 is moved along longitudinal axis 25 toward wrench head 16, D1 is increased and wrench 10 is in the open position (see e.g., FIG. 5).

Cam 36 of handle 12 extends away from neck 42 and includes a cam surface 46. Cam recess 34 includes an inner surface 48 that interfaces against cam surface 46 when cam 36 applies pressure to fixed jaw 18. Neck 42 includes an elongated opening or slot 50. Elongated opening 50 extends along longitudinal axis 25 of wrench 10.

Thumb slider 14 includes an engagement arm 52 positioned within cavity 28 of handle 12. Engagement arm 52 has in inner surface 54 that faces moveable jaw 20. Inner surface 54 of engagement arm 52 engages and/or pushes a portion of neck slider 44 when a user moves thumb slider 14 toward wrench head 16. Engagement arm 52 further includes an outer surface 70 that opposes inner surface 54. Cavity 28 includes an inward facing surface 68 that generally faces toward moveable jaw 20 and/or engagement arm 52. Specifically, inward facing surface 68 of cavity 28 faces outer surface 70 of engagement arm 52. As thumb slider 14 is used to adjust moveable jaw 20, a cavity distance, D2 defined between inward facing surface 68 of cavity 28 and outer surface 70 of engagement arm is changed. In other words, as wrench head 16 moves into the open position and D1 increases, the cavity distance D2 increases. Similarly, as wrench head 16 moves toward the closed position and D1 decreases, the cavity distance D2 decreases.

As previously mentioned, in a specific embodiment, moveable jaw 20 is spring loaded. Applicant believes spring loading moveable jaw 20 closed allows the wrench 10 to include a single handle 12 while maintaining a desired clamping force (i.e., apply enough force on the fastener to tighten and/or loosen the fastener without damaging the fastener) unlike similar hand tools which are not spring loaded and may require use of a second handle to maintain the clamping force. A bore 64 extends through engagement arm 52 with bore 64 configured to receive a fastener 56 (i.e., a retention screw), shown schematically, that extends into neck 42. Fastener 56 is coupled to a biasing member 62, shown schematically. In various embodiments, biasing member 62 is a spring. In specific embodiments, biasing member 62 is a tension spring. In other words, biasing member 62 provides a biasing or closing force on moveable jaw 20 to move or pull movable jaw 20 toward handle 12.

Biasing member 62 extends through a channel 58 in handle 12. Channel 58 is connected to cavity 28 of handle 12 at a first channel end 66. In a specific embodiment, channel 58 extends from cavity 28 at an angle (i.e., channel 58 is not parallel to longitudinal axis 25) toward distal end 38. Biasing member 62 is coupled to fastener 56 at a first end and coupled to an anchor 60 at a second, opposing end. Anchor 60 is at least partially positioned within handle 12 at a second channel end 67. In a specific embodiment, an outer surface of anchor 60 (i.e., facing away from portion connected to biasing member 62) is positioned outside of handle 12. In such an embodiment, second channel end 67 is open.

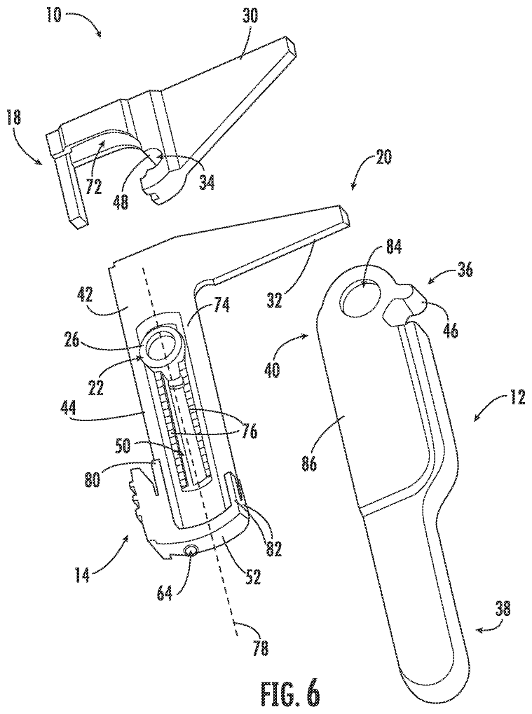

Referring to FIG. 6, a partially exploded view of the wrench 10 is shown, according to an exemplary embodiment. Neck 42, elongated opening 50, and neck slider 44 each extend along a longitudinal axis 78 of neck 42. In a specific embodiment, elongated opening 50 and neck slider 44 are centered about longitudinal axis 78 of neck 42. When wrench 10 is assembled, longitudinal axis 78 of neck 42 extends in the same or a parallel direction to longitudinal axis 25.

Fixed jaw 18 includes an open portion or channel 72. Channel 72 allows fixed jaw 18 to extend around and/or enclose neck 42 when wrench 10 is assembled. Neck 42 includes a bottom surface 74 with neck slider 44 positioned along and engaged with bottom surface 74. Specifically, neck slider 44 is engaged with a plurality of teeth 76 located on bottom surface 74 of neck 42. The plurality of teeth 76 are positioned along elongated opening 50 and extend along longitudinal axis 78 of neck 42. In a specific embodiment, the plurality of teeth 76 are positioned on both sides of elongated opening 50.

Thumb slider 14 further includes a first pair of gripping arms 80. The first pair of gripping arms 80 are coupled to engagement arm 52 and extend along longitudinal axis 78 toward moveable jaw 20. A second pair of gripping arms 82 are coupled to an opposing side of engagement arm 52. The second pair of gripping arms 82 extend along longitudinal axis 78, toward moveable jaw 20. The first and second pair of gripping arms 80, 82 each engage a side of neck 42 such that when thumb slider 14 is moved, neck 42 and moveable jaw 20 will also move.

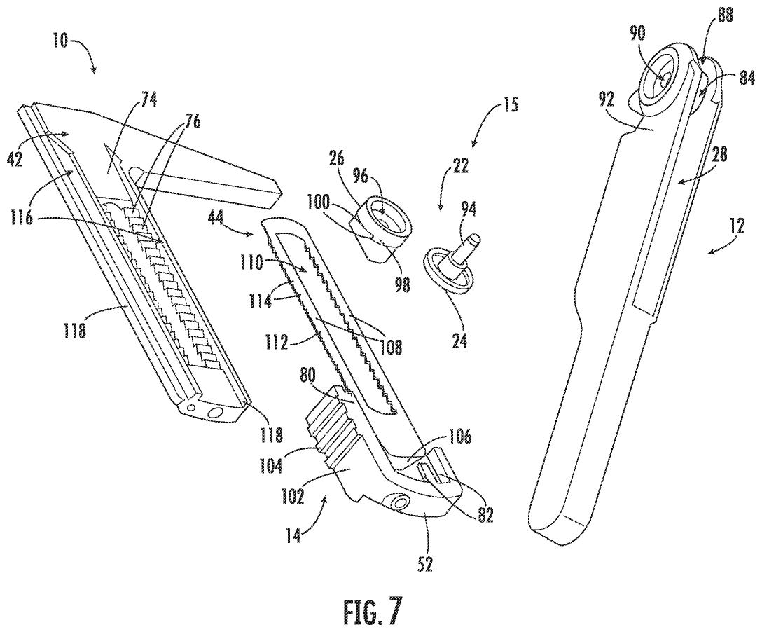

Referring to FIG. 7, an exploded view of the wrench 10 is shown, according to an exemplary embodiment. Proximal end 40 of handle 12 includes a first through bore 84 defined in a bottom surface 86 of handle 12. First through bore 84 receives release button 22 when wrench 10 is assembled. A second through bore 90 is defined in an upper surface 92 of handle 12 (see e.g., FIG. 7). Second through bore 90 has a dimension that is less than a dimension of through bore 84. Handle 12 includes a gap or space 88 positioned between first through bore 84 and second through bore 90.

A post 94 extends from a button portion 24 of release button 22. Post 94 is configured to engage a channel 96 that extends through receiver 26 of release button 22. Receiver 26 includes a pair of surfaces 98 that faces inward, toward cavity 28. Each surface 98 includes a plurality of teeth 100. When wrench 10 is assembled, teeth 100 of release button 22 and/or receiver 26 engage neck 42 and specifically the teeth 76 positioned along elongated opening 50.

Thumb slider 14 includes actuating surface 102 with protrusions 104. Actuating surface 102 is configured to be engaged by a user's thumb, allowing for use of adjustment mechanism 15 by a finger, thumb, and/or single hand while wrench 10 is grasped by the user. Actuating surface 102 extends in a generally parallel (i.e., parallel plus or minus 10 degrees) orientation to a rear side surface of handle 12 and is positioned adjacent to proximal end 40 of handle 12 and/or head 16. Thumb slider 14 and specifically actuating surface 102 faces in a direction away from the fixed jaw 18 and moveable jaw 20. In other words, fixed jaw 18 and moveable jaw 20 extend outward from head 16 in a first direction and thumb slider and actuating surface 102 face a second direction, opposite of the first direction.

Thumb slider 14 is positioned along a length of handle 12 defined between the proximal end 40 and the distal end 38. In various embodiments, thumb slider 14 is positioned in uppermost or proximal end 40 of handle 14. In various embodiments, thumb slider 14 is positioned in the uppermost 60% of handle 12, and more specifically, the uppermost 50% of handle 12.

Neck slider 44 further includes an engagement end 106 that interfaces against inner surface 54 of engagement arm 52. Neck slider 44 includes a pair of extensions 108 that extend from engagement end 106 on opposing sides of an elongated opening 110. Extensions 108 extends along longitudinal axis 78 of neck 42. In a specific embodiment, elongated opening 110 is centered about longitudinal axis 78 of neck 42. A plurality of teeth 114 are positioned along a bottom surface 112 of neck slider 44. Specifically, teeth 114 are positioned along extensions 108. In a specific embodiment, the plurality of teeth 114 are positioned on both sides of elongated opening 110.

As shown in FIG. 6, elongated opening 110 has a width that is greater than a width of elongated opening 50 such that teeth 100 of release button 22 can engage neck 42 and the plurality of teeth 76 at the same time the plurality of teeth 114 of neck slider 44 engage teeth 76. Additionally, at least a portion of each extension 108 is positioned between receiver 26 and neck 42 such that there is engagement between receiver 26 and neck slider 44 when the adjustment mechanism 15 is assembled. In other words, slider 44 is positioned between neck 42 and receiver 26 of release button 22.

Bottom surface 74 of neck 42 includes a pair of opposing walls 116. When neck slider 44 is engaged with bottom surface 74, neck slider 44 is positioned between the pair of opposing walls 116. Neck 42 further includes side projections 118 that extend outward and/or away from longitudinal axis 78 of neck 42 toward the sides of handle 12. One side projection 118 is positioned between and engaged the first pair of gripping arms 80 while the second side projection 118 is positioned between and engaged with the second pair of gripping arms 82.

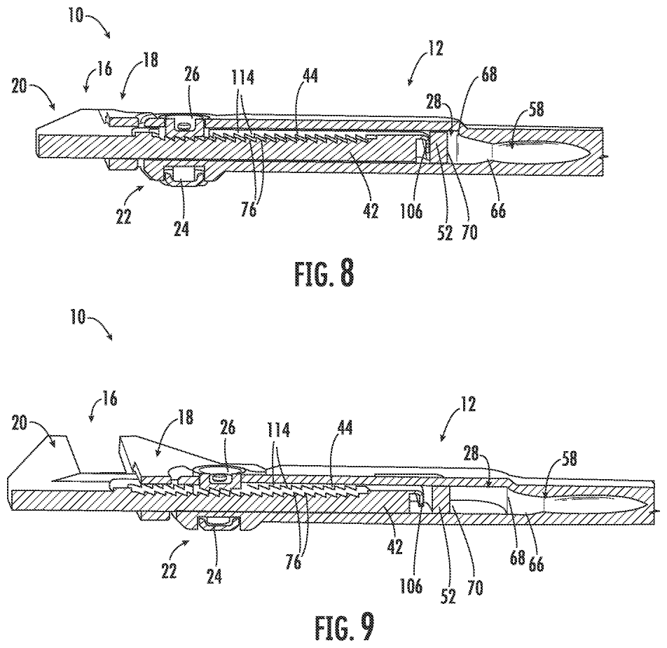

Referring to FIGS. 8-9, cross-sectional views of wrench 10 with wrench head 16 in the closed and open position are shown, according an exemplary embodiment. In order to move from the closed position to the open position, a user must provide a force to thumb slider 14 and specifically to actuating surface 102. As previously mentioned, there is engagement between extensions 108 of neck slider 44 and the receiver 26 of release button 22. As thumb slider 14 is moved toward moveable jaw 20, engagement end 106 is pushed, providing a force that moves neck slider 44. Compared to conventional hand tools that may use a sliding mechanism within a smooth groove, Applicant believes the use of teeth on components of the adjustment mechanism 15 provides a secure hold to maintain the position of the wrench head 16.

In general, the force from the thumb slider 14 moves wrench head 16 from a locked position in which teeth 114 move from engagement with the plurality of teeth 76 on the neck 42 while the extensions 108 also push and/or move release button 22 and teeth 100 of receiver 26 out of engagement with teeth 76 such that wrench head 16 and/or moveable jaw 20 can be adjusted (i.e., in head is in an unlocked position). When thumb slider 14 is released and there is no longer a force acting on the neck slider 44, teeth 114 and teeth 100 of release button 22 reengage with the plurality of teeth 76 on neck 42 moving the wrench head 16 back into a locked position. The reengagement between the teeth 114 of the neck slider 44, teeth 100 of release button 22 and the plurality of teeth 76 along neck 42 locks moveable jaw 20 back into place such it is fixed relative to handle 12 allowing the user to engage a workpiece.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. An adjustable wrench comprising:
a handle extending along a longitudinal axis;
a head comprising:
a fixed jaw coupled to the handle, the fixed jaw comprising a first contact surface; and
a moveable jaw slidably coupled to the handle, the moveable jaw comprising:
a neck extending along the longitudinal axis and positioned within the handle; and
a second contact surface, the second contact surface facing the first contact surface;
an adjustment mechanism comprising:
a neck slider extending along the longitudinal axis and facing the neck;
a switching device comprising an engagement arm, the engagement arm configured to engage the neck slider; and
a biasing member extending between and coupling the handle to the moveable jaw, the biasing member biasing the moveable jaw toward the handle;
wherein the head is adjustable between a closed position in which the moveable jaw is engaged with the fixed jaw and an open position in which the moveable jaw is spaced a distance from the fixed jaw.

2. The adjustable wrench of claim 1, wherein the biasing member provides a closing force on the moveable jaw such that the moveable jaw is pulled toward the fixed jaw.

3. The adjustable wrench of claim 1, the adjustment mechanism further comprising a locking mechanism, the locking mechanism comprising:
a release button extending through the neck of the moveable jaw, the neck slider, and the handle.

4. The adjustable wrench of claim 3, wherein, when the release button is in a locked position, the release button is engaged with the moveable jaw and resists movement of the moveable jaw such that the moveable jaw is secured relative to the handle.

5. The adjustable wrench of claim 3, wherein, when the release button is in an unlocked position, the release button is disengaged from the moveable jaw such that the moveable jaw is slidable relative to the handle.

6. The adjustable wrench of claim 3, the release button comprising:
a button portion; and
a receiver, the receiver positioned within handle and configured to receive the button portion and to engage with the neck of the moveable jaw.

7. The adjustable wrench of claim 1, the handle further comprising a cam extending away from the moveable jaw and the fixed jaw further comprising a recess shaped to receive the cam.

8. The adjustable wrench of claim 7, wherein the cam applies a force on the fixed jaw when a torque is applied to a workpiece.

9. The adjustable wrench of claim 1, wherein the handle is a single, integral component.

10. A wrench comprising:
a handle comprising a cavity;
a head comprising:
a fixed jaw coupled to the handle, the fixed jaw comprising a first contact surface; and
a moveable jaw slidably coupled to the handle, the moveable jaw comprising:
a neck extending along the handle and positioned within the cavity; and
a second contact surface, the second contact surface facing the first contact surface;
an adjustment mechanism comprising:
a neck slider extending along the neck and facing the neck;
a switching device comprising:
an actuating surface extending along a length of the handle; and
an engagement arm, the engagement arm extending into the cavity and configured to engage the neck slider; and
a spring extending between and coupling the handle to the moveable jaw;
wherein, when a user grasps the handle with a hand, the switching device is actuatable by the hand of the user.

11. The wrench of claim 10, wherein, when the switching device is actuated, a distance between the first contact surface and the second contact surface is changed.

12. The wrench of claim 10, wherein the actuating surface of the switching device extends along a longitudinal axis of the handle and wherein the actuating surface faces away from the fixed jaw and the moveable jaw.

13. The wrench of claim 10, the spring comprising:
a first end, the first end coupled to a fastener; and
a second end opposing the first end, the second end coupled to an anchor;
wherein the fastener is coupled to the moveable jaw.

14. The wrench of claim 10, wherein the spring provides a closing force on the moveable jaw such that the moveable jaw is pulled toward the handle.

15. The wrench of claim 10, further comprising a release button extending through the moveable jaw the release button interfacing against the moveable jaw to resist movement of the moveable jaw relative to the handle.

16. An adjustable wrench comprising:
a handle extending along a longitudinal axis;
a head comprising:
a fixed jaw coupled to the handle, the fixed jaw comprising a first contact surface; and
a moveable jaw slidably coupled to the handle, the moveable jaw comprising:
a neck extending along the longitudinal axis and positioned within the handle; and
a second contact surface, the second contact surface facing the first contact surface;
an adjustment mechanism comprising:
a neck slider extending along the longitudinal axis and engaged with the neck;
a switching device comprising an engagement arm, the engagement arm configured to engage the neck slider; and
a biasing member extending between and coupling the handle to the moveable jaw;
wherein, when the switching device is engaged by a user and moved toward the head, the engagement arm pushes the neck slider toward the head, moving the moveable jaw away from the handle.

17. The adjustable wrench of claim 16, wherein, when the switching device is released, the biasing member exerts a closing force on the moveable jaw such that the moveable jaw is pulled toward the fixed jaw.

18. The adjustable wrench of claim 16, wherein the neck comprises a first plurality of teeth facing the neck slider and the neck slider comprises a second plurality of teeth facing the neck.

19. The adjustable wrench of claim 18, wherein engagement between the first plurality of teeth of the neck and the second plurality of teeth of the neck slider resists movement of the moveable jaw relative to the handle.

20. The adjustable wrench of claim 18, further comprising a release button extending through the moveable jaw, the release button comprising a third plurality of teeth that interface against the first plurality of teeth to resist movement of the moveable jaw relative to the handle.
